(19) United States
(12) Patent Application Publication
(10) Pub. No.: US 2014/0351933 A1
(43) Pub. Date: Nov. 27, 2014

(54) SYSTEM AND METHOD FOR INSPECTING HARMFUL INFORMATION OF MOBILE DEVICE

(71) Applicant: ELECTRONICS AND TELECOMMUNICATIONS RESEARCH INSTITUTE, Daejeon (KR)

(72) Inventors: Seok-Hyun KIM, Daejeon (KR); Jin-Man CHO, Daejeon (KR); Young-Seob CHO, Daejeon (KR); Sang-Rae CHO, Daejeon (KR); Dae-Seon CHOI, Daejeon (KR); Jong-Hyouk NOH, Daejeon (KR); Soo-Hyung KIM, Daejeon (KR); Seung-Hyun KIM, Daejeon (KR); Seung-Hun JIN, Daejeon (KR)

(73) Assignee: ELECTRONICS AND TELECOMMUNICATIONS RESEARCH INSTITUTE, Daejeon (KR)

(21) Appl. No.: 14/273,739

(22) Filed: May 9, 2014

(30) Foreign Application Priority Data
May 22, 2013 (KR) 10-2013-0057985

(51) Int. Cl. H04L 29/06

(52) U.S. Cl. CPC H04L 63/1425
USPC 726/23

(57) ABSTRACT

Disclosed herein are a system and a method for inspecting harmful information of a mobile device capable of temporarily stopping an automatic access to a web site using access information for accessing a web site when the access information is obtained from various paths through a mobile device, requesting an inspecting server to inspect whether or not the corresponding web site includes harmful information, and receiving and displaying an inspection result in response to the request.

### CROSS REFERENCE TO RELATED APPLICATION

This application claims the benefit of Korean Patent Application No. 10-2013-0057985, filed on May 22, 2013, entitled “System and Method for Inspecting Harmful Information of Mobile Device”, which is hereby incorporated by reference in its entirety into this application.

### BACKGROUND OF THE INVENTION

1. Technical Field

The present invention relates to a method for inspecting harmful information, and more particularly, to a system and a method for inspecting harmful information of a mobile device capable of temporarily stopping an automatic access to a web site using access information for accessing a web site when the access information is obtained from various paths through a mobile device, requesting an inspecting server to inspect whether or not the corresponding web site includes harmful information, and receiving and displaying an inspection result in response to the request.

2. Description of the Related Art

Recently, as the number of users of smart phones has rapidly increased to thirty million, damage targeting the smart phone has been variously generated. As a typical example of damage, there may be an example in which an excessive cost is charged to users by distributing a short message service (SMS) message in which a malicious code is concealed. In addition, as various wireless communication technologies have been applied to the smart phones, a movie poster, a promotional flyer, and the like, in which the malicious code is concealed have been distributed in a form of a near field communication (NFC) tag or a quick response (QR) code, such that personal information of the users of the smart phones has been continuously leaked and financial damage to the users of the smart phones has continuously increased.

The above-mentioned attack is possible for the following two main reasons.

A first reason is that it is difficult for the users to directly confirm or inspect information received through the smart phones. In addition, a shortening universal resource locator (URL) service shortening a general URL address has been recently used frequently. In the shortening URL service, it is impossible even for users having knowledge of the related field to directly identify and confirm a corresponding URL.

A second reason is a functional problem of the smart phone emphasizing only convenience of the user. That is, an NFC communication function mounted in the smart phone is directly executed without confirmation of received information (URL or phone number) by the user. Attackers may perform a mobile phishing attack more easily in the smart phone than in a personal computer (PC) by distributing NFC tags into which malicious codes are inserted everywhere misusing this scheme.

However, research into a technology for preventing invasion of the malicious codes has been mainly conducted based on the PC. Recently, due to an increase in the number of mobile malicious codes and diversification of a scheme of distributing the mobile malicious codes, research into a technology for preventing invasion of the malicious codes in a mobile environment has been conducted.

### SUMMARY OF THE INVENTION

An object of the present invention is to provide a system and a method for inspecting harmful information of a mobile device capable of temporarily stopping an automatic access to a web site using access information for accessing a web site when the access information is obtained from various paths through a mobile device, requesting an inspecting server to inspect whether or not the corresponding web site includes harmful information, and receiving and displaying an inspection result in response to the request.

However, an object of the present invention is not limited to the object described above, and other objects that are not stated may be clearly understood by those skilled in the art from the following description.

According to an exemplary embodiment of the present invention, there is provided a mobile device including: a communicating unit operating with an inspecting server through wireless communication to transmit or receive various information to or from the inspecting server; an inputting unit receiving information depending on a menu or key operation input from a user; a controlling unit temporarily stopping an automatic access to a web site when it obtains access information for accessing the web site through an activated dedicated application depending on the information input from the user, requesting the inspecting server to inspect whether or not the web site is a harmful site, and receiving an inspection result in response to the request; a displaying unit displaying an image of a main page and evaluation information of the corresponding web site included in the received inspection result on a screen of the dedicated application; and a storing unit storing the image of the main page and the evaluation information of the corresponding web site.

The access information may be a uniform resource locator (URL) for accessing the web site or a phone number.

The controlling unit may perform the automatic access to the corresponding web site when a total evaluation score for the corresponding web site included in the evaluation information is a preset threshold value or more.

The evaluation information may include a total evaluation score generated by summing an evaluation score of a professional and an evaluation score of the user for the corresponding web site at a preset ratio and a harmful grade indicating a safety degree or a danger degree depending on the total evaluation score.

The controlling unit may control the displaying unit to display the obtained access information and the image of the main page and the evaluation information of the web site corresponding to the access information without performing the automatic access to the corresponding web site when a total evaluation score for the corresponding web site included in the evaluation information is less than a preset threshold value.

The controlling unit may control the displaying unit to display the obtained access information and the image of the main page and the evaluation information of the web site corresponding to the access information and perform a control to access a web site corresponding to the selected access information when the access information is selected depending on the information input from the user.

According to another exemplary embodiment of the present invention, there is provided a system for inspecting harmful information of a mobile device, including: an inspecting server inspecting whether or not a web site corresponding to access information is a harmful site based on evaluation of a professional or a user when it receives the access information from the mobile device and transmitting an image of a main page and evaluation information of the web site corresponding to the access information as an inspection result to the mobile device; and a database storing the access information and the image of the main page and the evaluation information of the web site, wherein the access information is a URL for accessing the web site or a phone number.

The inspecting server may automatically access the web site corresponding to the access information when it receives the access information from the mobile device and capture a main page of the automatically accessed web site to generate an image of the main page.

The inspecting server may generate a total evaluation score by summing an evaluation score of the professional and an evaluation score of the user for the corresponding web site at a preset ratio, judge a harmful grade indicating a safety degree or a danger degree depending on the total evaluation score, and generate the evaluation information including at least one of the total evaluation score and the harmful grade.

According to still another exemplary embodiment of the present invention, there is provided a method of inspecting harmful information of a mobile device, including: activating a dedicated application depending on information input from a user and obtaining access information for accessing a web site through the activated dedicated application; temporarily stopping an automatic access to the web site corresponding to the obtained access information, requesting an inspecting server to inspect whether or not the web site is a harmful site, and receiving an inspection result in response to the request; and displaying an image of a main page and evaluation information of the corresponding web site included in the inspection result received from the inspecting server on a screen of the dedicated application.

The access information may be a URL for accessing the web site or a phone number.

In the displaying, the automatic access to the corresponding web site may be performed when a total evaluation score for the corresponding web site included in the evaluation information is a preset threshold value or more.

The evaluation information may include a total evaluation score generated by summing an evaluation score of a professional and an evaluation score of the user for the corresponding web site at a preset ratio and a harmful grade indicating a safety degree or a danger degree depending on the total evaluation score.

In the displaying, the obtained access information and the image of the main page and the evaluation information of the web site corresponding to the access information may be displayed without performing the automatic access to the corresponding web site when a total evaluation score for the corresponding web site included in the evaluation information is less than a preset threshold value.

In the displaying, the obtained access information and the image of the main page and the evaluation information of the web site corresponding to the access information may be displayed, and an access to a web site corresponding to the selected access information may be performed when the access information is selected by the user.

According to yet still another exemplary embodiment of the present invention, there is provided a method of inspecting harmful information of a mobile device, including: inspecting whether or not a web site corresponding to access information is a harmful site based on evaluation of a professional or a user when the access information is received from the mobile device; transmitting an image of a main page and evaluation information of the web site corresponding to the access information as an inspection result to the mobile device; and storing the access information and the image of the main page and the evaluation information of the web site in the database, wherein the access information is a URL for accessing the web site or a phone number.

In the inspecting, a type of access information may be identified when the access information is received from the mobile device, an automatic access to the web site corresponding to the access information may be performed when the access information is URL information as an identification result, and a main page of the automatically accessed web site may be captured, such that an image of the main page is generated.

In the inspecting, a total evaluation score may be generated by summing an evaluation score of the professional and an evaluation score of the user for the corresponding web site at a preset ratio, a harmful grade indicating a safety degree or a danger degree depending on the total evaluation score may be judged, and the evaluation information including at least one of the total evaluation score and the harmful grade maybe generated.

### BRIEF DESCRIPTION OF THE DRAWINGS

FIG. 1 is a view illustrating a system for inspecting harmful information according to an exemplary embodiment of the present invention;

FIG. 2 is a view illustrating a detailed configuration of a mobile device according to the exemplary embodiment of the present invention;

FIG. 3 is a view illustrating a screen for displaying an inspection result according to the exemplary embodiment of the present invention;

FIG. 4 is a view illustrating a detailed configuration of an inspecting server according to the exemplary embodiment of the present invention; and

FIG. 5 is a view illustrating a method for inspecting harmful information according to the exemplary embodiment of the present invention.

### DESCRIPTION OF THE EXEMPLARY EMBODIMENTS

Hereinafter, a system and a method for inspecting harmful information of a mobile device according to an exemplary embodiment of the present invention will be described with reference to the accompanying drawings. Portions required for understanding an operation and an action according to the present invention will be described in detail.

Further, in describing components of the present invention, components having the same name may be denoted by different reference numerals in each of the drawings and be denoted by the same reference numerals in different drawings. However, even in this case, corresponding components may not have different functions in each of exemplary embodiments or may not have the same function in different exemplary embodiments, and functions of the respective components should be judged based on a description of the respective components in corresponding exemplary embodiments.

Particularly, the present invention suggests a new method for inspecting harmful information capable of temporarily stopping an automatic access to a web site using access information for accessing a web site when the access information is obtained from various paths through a mobile device, requesting an inspecting server to inspect whether or not the corresponding web site includes harmful information, and receiving and displaying an inspection result in response to the request. These functions are processed in a mobile device.

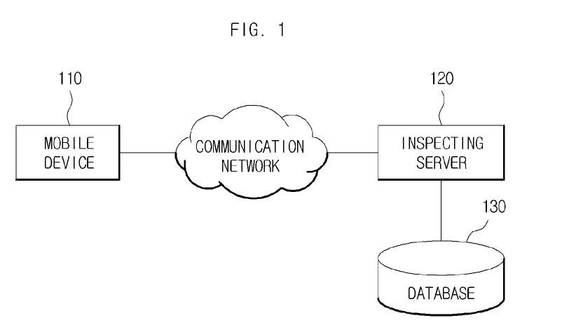

FIG. 1 is a view illustrating a system for inspecting harmful information according to an exemplary embodiment of the present invention.

As illustrated in FIG. 1, the system for inspecting harmful information according to the exemplary embodiment of the present invention may be configured to include a mobile device 110, an inspecting server 120, a database 120, and the like.

The mobile device 110 may obtain access information for accessing a specific web site through various ways, for example, a near field communication (NFC) tag, a quick response (QR) code, a short message service (SMS) message, a social network service (SNS), and the like, using a dedicated application. Here, the access information may be a uniform resource locator (URL) of the web site, a phone number, or the like.

The mobile device 100 is a device in which the Internet function is implemented and to which various wireless communication technologies are applied and may conceptually include, for example, a smart phone, a tablet personal computer (PC), a personal digital assistant (PDA), a laptop computer, or the like.

The mobile device 110 may temporarily stop the automatic access to the web site using the obtained access information, request the inspecting server to inspect whether or not the corresponding web site is a harmful site including harmful information, and receive the inspection result including an image of a main page of the corresponding web site in response to the request, and display the received inspection result so as to be confirmed by a user.

The mobile device 110 may perform the automatic access to the corresponding web site when it is judged that the corresponding web site is a safe site rather than the harmful site, depending on the received inspection result.

Here, the harmful information is a malicious code generally indicating an executable code created for a malicious purpose and divided into a virus, a worm, a Trojan horse, and the like, depending on whether or not self-replication capability and an infection target are present.

The inspecting server 120 may inspect whether or not the corresponding web site is the harmful site based on the access information when it receives the access information from the mobile device.

The inspecting server 120 may access the corresponding web site based on the received access information, automatically capture a screen of a main page of the accessed web site, and generate an image or a preview image of the main page of the corresponding web site as a capture result.

The inspecting server 120 may sum an evaluation score of a professional and an evaluation score of a user for the corresponding web site based on the received access information to generate a total evaluation score, judge a harmful degree of the corresponding web site based on the generated total evaluation score, and generate evaluation information including a judgment result and the total evaluation score.

The inspecting server 120 may provide the image of the main page and the evaluation information of the corresponding web site generated as described above to the mobile device.

The database 130 may store and manage URL information or phone numbers of web sites requested to be inspected, together with images of main pages and evaluation information of each of the corresponding web sites.

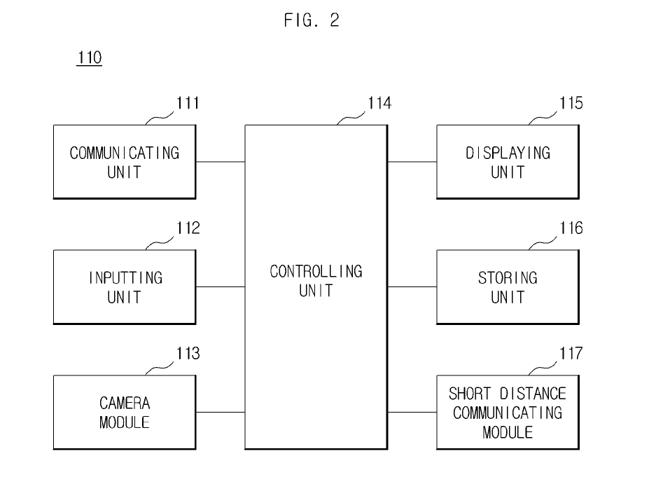

FIG. 2 is a view illustrating a detailed configuration of a mobile device according to the exemplary embodiment of the present invention.

As illustrated in FIG. 2, the mobile device 110 according to the exemplary embodiment of the present invention may be configured to include a communicating unit 111, an inputting unit 112, a camera module 113, a controlling unit 114, a displaying unit 115, a storing unit 116, a short distance communicating module 117, and the like.

The communicating unit 111 may operate with the inspecting server through wireless communication to transmit or receive various information to or from the inspecting server. For example, the communicating unit 111 transmits access information for accessing a specific web site that is to be accessed to the inspecting server and receives an image of a main page of the corresponding web site and inspection result information from the inspecting server.

The inputting unit 112 may receive information depending on a menu or key operation input from a user.

The camera module 113 may photograph a QR code and output an image of the photographed QR code.

The short distance communicating module 117 may recognize an electronic tag and output information on the recognized electronic tag. For example, the short distance communicating module may be an NFC module, a radio frequency identification (RFID) reader, or the like.

The controlling unit 114 may activate a dedicated application depending on selection of the user and obtain access information for accessing the web site from various paths through the activated dedicated application. For example, the controlling unit 114 may obtain the access information from 1) an image of the QR code, 2) the information on the electronic tag, 3) a pre-stored text message, or 4) a social network service (SNS).

The controlling unit 114 may temporarily stop an automatic access to the corresponding web site based on the access information when it obtains the access information, request the inspecting server to inspect the access information, and receive an image of a main page and evaluation information of the corresponding web site in response to the request.

The controlling unit 114 may perform the automatic access to the corresponding web site based on a total evaluation score included in the evaluation information when it receives the image of the main page and the evaluation information. For example, the controlling unit 114 performs the automatic access to the corresponding web site when the total evaluation score for the corresponding web site is a preset threshold value or more and controls the displaying unit 115 to display the access information and the image of the main page and the evaluation information of the web site corresponding to the access information without performing the automatic access to the corresponding web site when the total evaluation score for the corresponding web site is less than the preset threshold value.

The controlling unit 114 may receive an evaluation score for the corresponding web site input from the user and transmit the input evaluation score to the inspecting server. The evaluation score transmitted to the inspecting server as described above is later used to evaluate the corresponding web site.

The displaying unit 115 may display the image of the main page and the evaluation information of the corresponding web site as an inspection result for the web site corresponding to the corresponding access information from the inspecting server.

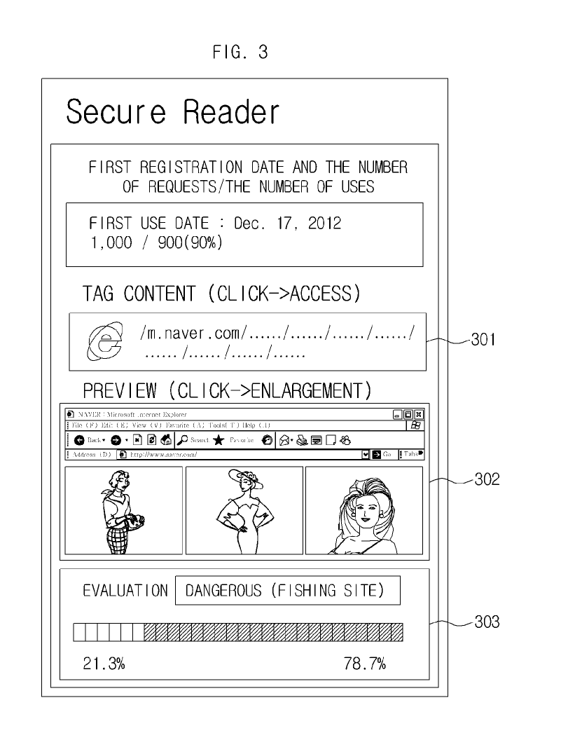

FIG. 3 is a view illustrating a screen for displaying an inspection result according to the exemplary embodiment of the present invention.

As illustrated in FIG. 3, the mobile device according to the exemplary embodiment of the present invention may display an inspection result for access information through a dedicated application. For example, the mobile device according to the exemplary embodiment of the present invention displays a URL 301 of a corresponding web site, an image 302 of a main page of the corresponding web site, and evaluation information 303 of the corresponding web site in the case in which the access information is obtained from an NFC tag, thereby allowing a user to judge whether or not he/she will access the corresponding web site.

That is, since the mobile device performs an automatic access to the corresponding web site when a total evaluation score included in the evaluation information is a preset threshold value or more, it does not need to receive selection of the user for an access to the corresponding web site. On the other hand, since the mobile device does not perform the automatic access to the corresponding web site when the total evaluation score included in the evaluation information is less than the preset threshold value, it receives selection of the user for an access to the corresponding web site to perform an access to the corresponding web site.

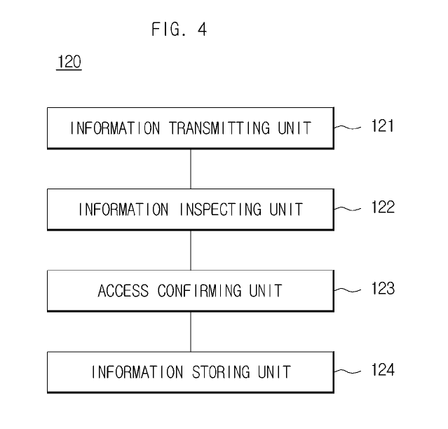

FIG. 4 is a view illustrating a detailed configuration of an inspecting server according to the exemplary embodiment of the present invention.

As illustrated in FIG. 4, the inspecting server 120 according to the exemplary embodiment of the present invention may be configured to include an information transmitting unit 121, an information inspecting unit 122, an access confirming unit 123, an information storing unit 124, and the like.

The information transmitting unit 121 may operate with the mobile device through wireless communication to transmit and receive various information to and from the mobile device. For example, the information transmitting unit 121 receives access information that is to be inspected from the mobile device and transmits an inspection result for the access information to the mobile device.

The information inspecting unit 122 may inspect reliability of a web site corresponding to the access information when it receives the access information from the mobile device. That is, the information inspecting unit 122 may inspect whether or not the corresponding web site is a harmful site including harmful information and generate inspection result information as an inspection result.

In this case, the information inspecting unit 122 may sum an evaluation score of a professional and an evaluation score of a user for the corresponding web site at a preset ratio to generate a total evaluation score and judge a harmful grade indicating a safety degree or a danger degree of the corresponding web site based on the generated total evaluation score.

The total evaluation score generated as described above may be calculated by the following Equation 1.

### Equation 1

Total Evaluation Score=Evaluation Score of Professional×0.7+Evaluation Score of User×0.3

The evaluation score of the user indicates a score for the corresponding web site input from the user. For example, the evaluation score of the user is differently scored depending on a danger degree of each item.

The evaluation score of the professional indicates a score for the corresponding web site input from the professional. For example, the evaluation score of the professional is differently scored depending on a danger degree of each item.

For example, the professional performs evaluation for each of a plurality of items as shown in the following Table 1.

TABLE 1

| Item | Evaluation Content | Evaluation |
|---|---|---|
| Confirmation of | Confirmation of Domain Information | Safety/Caution/Danger |
| URL Address | through Whois | |
| | Confirmation of Domain Alteration and | |
| | Counterfeiting | |
| Analysis of | Confirmation of Whether or not Automatic | Safety/Caution/Danger |
| Javascript | Program has been Installed and | |
| | Redirection Link has been Connected | |
| Debugging of | Detection of Malicious Action through | Safety/Caution/Danger |
| Programming Source | Analysis of Installed Program Source | |
| Analysis of | Confirmation of Whether or not Registry | Safety/Caution/Danger |
| Registry | has been Accessed or Altered | |

When a score is evaluated for each item, as described above, and is converted into a preset score, it becomes the evaluation score of the professional.

Here, although the case in which the total evaluation score is calculated by summing the evaluation score of the professional and the evaluation score of the user has been described in the exemplary embodiment of the present invention, the present invention is not necessary limited thereto. That is, the total evaluation score may be calculated only using any one of the evaluation score of the professional and the evaluation score of the user.

In addition, although the case in which the total evaluation score is calculated by the above Equation 1 has been described in the exemplary embodiment of the present invention, the present invention is not limited to the above Equation 1 or the evaluation item, but may be variously applied.

The access confirming unit 123 may attempt an automatic access to a corresponding web site in the case in which the received access information is the web site URL to confirm whether or not the access to the web site has been normally performed and may capture a main page of the normally accessed web site to generate an image of the main page.

In this case, when information on a corresponding web site requested to be inspected is stored in the database, the access confirming unit 123 uses an image of a main page of the corresponding web site stored in the database as it is, and when the information on the corresponding web site is not stored in the database, the access confirming unit 123 attempts the automatic access to the corresponding web site to confirm whether or not the access to the corresponding web site has been normally performed and captures a main page of the normally accessed web site to generate an image of the main page.

In addition, the access confirming unit 123 may regularly update whether or not the access to the corresponding web site has been normally performed, the image of the main page of the corresponding web site, and the like.

The information storing unit 124 may store URL information of web sites requested to be inspected and images of main pages and evaluation information of each of the corresponding web sites in the database.

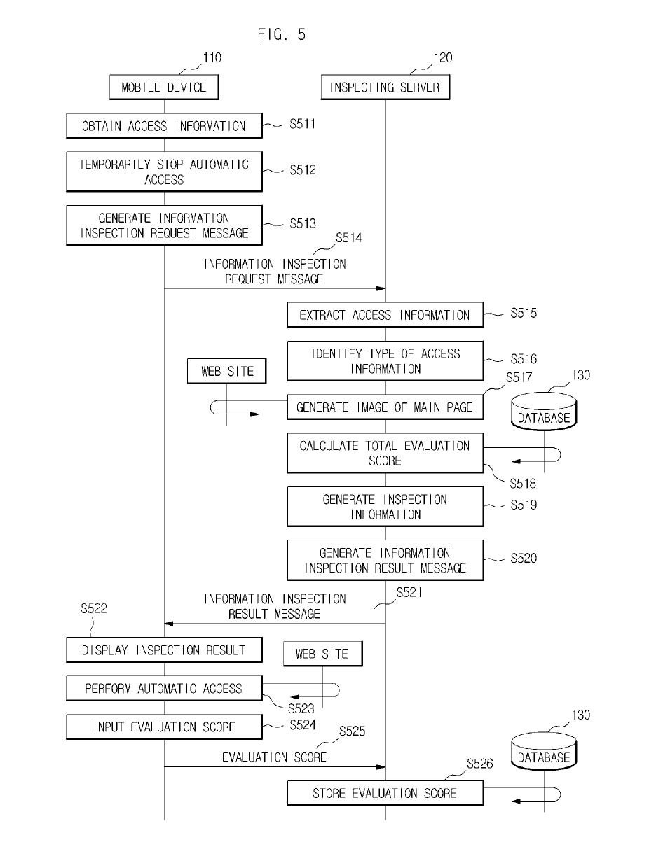

FIG. 5 is a view illustrating a method for inspecting harmful information according to the exemplary embodiment of the present invention.

As illustrated in FIG. 5, when the mobile device according to the exemplary embodiment of the present invention obtains access information for accessing a web site from various paths (S511), it may temporarily stop an automatic access to the web site using the obtained access information (S512).

Then, the mobile device may generate an information inspection request message including the obtained access information (S513) and transmit the generated information inspection request message to the inspecting server to request the inspecting server to inspect whether or not the corresponding web site includes harmful information (S514).

Next, when the inspecting server receives the information inspection request message, it may extract the access information included in the received information inspection request message (S515) and identify a type of extracted access information (S516).

Here, the type of access information may be URL information, a phone number, or the like.

Next, in the case in which the access information is the URL information, the inspecting server may automatically access the corresponding web site based on the corresponding access information and capture a main page of the automatically accessed web site to generate an image of the main page (S517).

On the other hand, in the case in which the access information is the phone number, the inspecting server provides information on whether or not the corresponding phone number is a pre-reported voice fishing phone number, a pre-evaluated score, and the like.

Then, the inspecting server may generate a total evaluation score by summing a pre-stored evaluation score of a professional and an evaluation score of a user for the web site corresponding to the access information (S518).

Next, the inspecting server may judge a harmful grade of the corresponding web site based on the generated total evaluation score and generate evaluation information including a judgment result and the total evaluation score (S519). Here, the harmful grade may be divided into safety, caution, danger, and the like.

Next, the inspecting server may generate an information inspection result message including the image of the main page and the evaluation information (S520) and transmit the generated information inspection result message to the mobile device (S521).

Next, when the mobile device receives the information inspection result message, it may display the image of the main page and the evaluation information included in the received information inspection result message (S522).

Next, the mobile device may perform an automatic access to the corresponding web site based on the total evaluation score in the evaluation information (S523). That is, the mobile device performs the automatic access to the corresponding web site when the total evaluation score is a preset threshold value or more and does not perform the automatic access to the corresponding web site when the total evaluation score is less than the preset threshold value.

Next, when the user ends the use of the corresponding web site, the mobile device may receive an evaluation score for the corresponding web site input from the user (S524) and transmit the input evaluation score to the inspecting server (S525).

Next, when the inspecting server receives the evaluation score, it may store the received evaluation score (S526). That is, the inspecting server accumulates the received evaluation score in evaluation scores of users for the corresponding web site. This evaluation score is later reflected at the time of calculating a total evaluation score.

As set forth above, according to the exemplary embodiment of the present invention, a user may confirm a web site without directly accessing the web site by temporarily stopping an automatic access to the web site using access information for accessing the web site when the access information is obtained from various paths, requesting an inspecting server to inspect whether or not the corresponding web site includes harmful information, and receiving and displaying an inspection result in response to the request.

In addition, according to the exemplary embodiment of the present invention, since the user may confirm the web site without directly accessing the web site, leakage of personal information and financial damage due to the harmful information may be prevented.

Further, according to the exemplary embodiment of the present invention, since the user may confirm the web site without directly accessing the web site, anxiety in using the access information obtained from various paths may be decreased.

Meanwhile, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

The exemplary embodiments of the present invention described hereinabove are only an example of the present invention and may be variously modified and altered by those skilled in the art to which the present invention pertains without departing from essential features of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall with the scope of the present invention.

What is claimed is:

1. A mobile device comprising:
a communicating unit operating with an inspecting server through wireless communication to transmit or receive various information to or from the inspecting server;
an inputting unit receiving information depending on a menu or key operation input from a user;
a controlling unit temporarily stopping an automatic access to a web site when it obtains access information for accessing the web site through an activated dedicated application depending on the information input from the user, requesting the inspecting server to inspect whether or not the web site is a harmful site, and receiving an inspection result in response to the request;
a displaying unit displaying an image of a main page and evaluation information of the corresponding web site included in the received inspection result on a screen of the dedicated application; and
a storing unit storing the image of the main page and the evaluation information of the corresponding web site.

2. The mobile device of claim 1, wherein the access information is a uniform resource locator (URL) for accessing the web site or a phone number.

3. The mobile device of claim 1, wherein the controlling unit performs the automatic access to the corresponding web site when a total evaluation score for the corresponding web site included in the evaluation information is a preset threshold value or more.

4. The mobile device of claim 3, wherein the evaluation information includes a total evaluation score generated by summing an evaluation score of a professional and an evaluation score of the user for the corresponding web site at a preset ratio and a harmful grade indicating a safety degree or a danger degree depending on the total evaluation score.

5. The mobile device of claim 1, wherein the controlling unit controls the displaying unit to display the obtained access information and the image of the main page and the evaluation information of the web site corresponding to the access information without performing the automatic access to the corresponding web site when a total evaluation score for the corresponding web site included in the evaluation information is less than a preset threshold value.

6. The mobile device of claim 5, wherein the controlling unit controls the displaying unit to display the obtained access information and the image of the main page and the evaluation information of the web site corresponding to the access information and performs a control to access a web site corresponding to the selected access information when the access information is selected depending on the information input from the user.

7. A system for inspecting harmful information of a mobile device, comprising:
an inspecting server inspecting whether or not a web site corresponding to access information is a harmful site based on evaluation of a professional or a user when it receives the access information from the mobile device and transmitting an image of a main page and evaluation information of the web site corresponding to the access information as an inspection result to the mobile device; and
a database storing the access information and the image of the main page and the evaluation information of the web site,
wherein the access information is a URL for accessing the web site or a phone number.

8. The system of claim 7, wherein the inspecting server identifies a type of access information when it receives the access information from the mobile device, automatically accesses the web site corresponding to the access information when the access information is URL information as an identification result, and captures a main page of the automatically accessed web site to generate an image of the main page.

9. The system of claim 7, wherein the inspecting server generates a total evaluation score by summing an evaluation score of the professional and an evaluation score of the user for the corresponding web site at a preset ratio, judges a harmful grade indicating a safety degree or a danger degree depending on the total evaluation score, and generates the evaluation information including at least one of the total evaluation score and the harmful grade.

10. A method of inspecting harmful information of a mobile device, comprising:
activating a dedicated application depending on information input from a user and obtaining access information for accessing a web site through the activated dedicated application;
temporarily stopping an automatic access to the web site corresponding to the obtained access information, requesting an inspecting server to inspect whether or not the web site is a harmful site, and receiving an inspection result in response to the request; and
displaying an image of a main page and evaluation information of the corresponding web site included in the inspection result received from the inspecting server on a screen of the dedicated application.

11. The method of claim 10, wherein the access information is a URL for accessing the web site or a phone number.

12. The method of claim 10, wherein in the displaying, the automatic access to the corresponding web site is performed when a total evaluation score for the corresponding web site included in the evaluation information is a preset threshold value or more.

13. The method of claim 12, wherein the evaluation information includes a total evaluation score generated by summing an evaluation score of a professional and an evaluation score of the user for the corresponding web site at a preset ratio and a harmful grade indicating a safety degree or a danger degree depending on the total evaluation score.

14. The method of claim 10, wherein in the displaying, the obtained access information and the image of the main page and the evaluation information of the web site corresponding to the access information are displayed without performing the automatic access to the corresponding web site when a total evaluation score for the corresponding web site included in the evaluation information is less than a preset threshold value.

15. The method of claim 14, wherein in the displaying, the obtained access information and the image of the main page and the evaluation information of the web site corresponding to the access information are displayed, and an access to a web site corresponding to the selected access information is performed when the access information is selected by the user.

16. A method of inspecting harmful information of a mobile device, comprising:
inspecting whether or not a web site corresponding to access information is a harmful site based on evaluation of a professional or a user when the access information is received from the mobile device;
transmitting an image of a main page and evaluation information of the web site corresponding to the access information as an inspection result to the mobile device; and
storing the access information and the image of the main page and the evaluation information of the web site in the database,
wherein the access information is a URL for accessing the web site or a phone number.

17. The method of claim 16, wherein in the inspecting, a type of access information is identified when the access information is received from the mobile device, an automatic access to the web site corresponding to the access information is performed when the access information is URL information as an identification result, and a main page of the automatically accessed web site is captured, such that an image of the main page is generated.

18. The method of claim 16, wherein in the inspecting, a total evaluation score is generated by summing an evaluation score of the professional and an evaluation score of the user for the corresponding web site at a preset ratio, a harmful grade indicating a safety degree or a danger degree depending on the total evaluation score is judged, and the evaluation information including at least one of the total evaluation score and the harmful grade is generated.
